(19) United States
(12) Patent Application Publication
(10) Pub. No.: US 2013/0132307 A1
(43) Pub. Date: May 23, 2013

(54) MANAGING THE USE OF SECURE COMPARTMENTS IN CHARGING STATIONS FOR PORTABLE ELECTRONIC DEVICES

(71) Applicants: Jack Standish Phelps, Brooklyn, NY (US); Adam H. Johnson, New York, NY (US)

(72) Inventors: Jack Standish Phelps, Brooklyn, NY (US); Adam H. Johnson, New York, NY (US)

(73) Assignee: RWDG ENTERPRISES, INC., New York, NY (US)

(21) Appl. No.: 13/298,888

(22) Filed: Nov. 17, 2011

(51) Int. Cl. G06F 17/00; H02J 7/00

(52) U.S. Cl. 705/412; 320/115

(57) ABSTRACT

The disclosed embodiments provide a charging station for portable electronic devices. During operation, the charging station obtains input from a user to the charging station. If the input matches an ongoing transaction associated with charging of the portable electronic device by the charging station, the charging station uses the input to identify a first secure compartment of the charging station containing the portable electronic device, wherein power is supplied to the portable electronic device within the first secure compartment. Next, the charging station releases a first door of the first secure compartment. Finally, upon detecting a presence of the portable electronic device in the first secure compartment after the first door is subsequently closed, the charging station secures the first door and continues to supply power to the portable electronic device without requiring additional input from the user.

### BACKGROUND

1. Field

The disclosure relates to charging stations for portable electronic devices. More specifically, the disclosure relates to techniques for managing the use of secure compartments in charging stations for portable electronic devices.

2. Description of the Related Art

Rechargeable batteries are commonly used to power a variety of portable electronic devices, such as laptop computers, tablet computers, mobile phones, personal digital assistants (PDAs), digital cameras, and/or portable media players. The capacities and/or runtimes of such batteries may vary based on the power consumption of the portable electronic devices, usage of the portable electronic devices, the size and chemistry of the batteries, and/or the age of the batteries. For example, a single charge on a smart phone's battery may last multiple days if the smart phone is in standby mode and for less than a day if the smart phone is constantly used to browse the web, send and receive emails, play games, view documents, and/or make phone calls. Similarly, a rechargeable battery's capacity may gradually decrease over time, with the battery reaching an end-of-life when the battery's capacity drops to a percentage (e.g., 70-80%) of the battery's initial capacity.

Continued use of a portable electronic device without recharging the portable electronic device's battery may deplete the battery and interrupt the use of the portable electronic device. At the same time, the portable electronic device's location may be inconvenient and/or unsafe for recharging of the battery. For example, a user may receive a warning from his/her mobile phone after the mobile phone's battery level falls below 15%. If the user continues using the mobile phone without charging the battery, the battery may run out of charge, and the mobile phone may switch off. Once the battery is dead, the user may be unable to restore operation of the mobile phone until the user has access to a suitable phone charger and/or power outlet. Moreover, the user may risk damage to and/or theft of the mobile phone if the user attempts to charge the mobile phone in a public setting such as a restaurant, bar, airport, and/or gym.

Consequently, uninterrupted use of portable electronic devices may be facilitated by mechanisms for securely charging the portable electronic devices in public settings.

### SUMMARY

The disclosed embodiments provide a charging station for portable electronic devices. During operation, the charging station obtains input from a user to the charging station. If the input matches an ongoing transaction associated with charging of the portable electronic device by the charging station, the charging station uses the input to identify a first secure compartment of the charging station containing the portable electronic device, wherein power is supplied to the portable electronic device within the first secure compartment. Next, the charging station releases a first door of the first secure compartment. Finally, upon detecting a presence of the portable electronic device in the first secure compartment after the first door is subsequently closed, the charging station secures the first door and continues to supply power to the portable electronic device without requiring additional input from the user.

In one or more embodiments, the charging station also queries the user for approval to continue charging the portable electronic device after the first door is subsequently closed. The charging station may query the user by providing an option to continue charging the portable electronic device and providing an option to discontinue charging the portable electronic device. The option to continue charging the portable electronic device may be associated with an added fee to the user. If the approval is not obtained from the user, the charging station releases the first door.

In one or more embodiments, upon detecting an absence of the portable electronic device in the first secure compartment after the first door is subsequently closed, the charging station secures the first door and ends the ongoing transaction.

In one or more embodiments, if the input matches a recently ended transaction associated with charging of the portable electronic device by the charging station, the charging station uses the input to identify a second secure compartment of the charging station, wherein the second secure compartment is associated with the recently ended transaction. The charging station then releases a second door of the second secure compartment.

In one or more embodiments, if the input does not match the ongoing transaction or the recently ended transaction, the charging station selects a third secure compartment of the charging station and releases a third door of the third secure compartment. The charging station then initiates a transaction associated with charging of the portable electronic device within the third secure compartment.

In one or more embodiments, upon detecting a presence of two or more portable electronic devices in the third secure compartment, the charging station processes the transaction based on the detected presence of the two or more portable electronic devices in the third secure compartment.

In one or more embodiments, the presence of the two or more portable electronic devices in the third secure compartment is detected using a set of connectors in the third secure compartment, a total power consumption associated with the third secure compartment, and/or a change in power consumption in the third secure compartment.

In one or more embodiments, processing the transaction based on the detected presence of the two or more portable electronic devices in the third secure compartment involves ceasing to supply power to at least one of the two or more portable electronic devices, increasing a fee associated with the transaction, and/or prompting the user to remove at least one of the two or more portable electronic devices from the third secure compartment.

In one or more embodiments, the input from the user includes a selection of the first secure compartment and/or an identifier for the user. The identifier for the user may include a password, a numeric code, personal information, payment information, and/or biometric data.

In one or more embodiments, releasing the first door of the first secure compartment involves unlocking the first door and/or opening the first door.

### BRIEF DESCRIPTION OF THE DRAWINGS

FIG. 1 shows a charging station in accordance with one or more embodiments.

FIG. 2 shows a schematic of a system in accordance with one or more embodiments.

FIG. 3 shows a flowchart illustrating the process of operating a charging station for a portable electronic device in accordance with one or more embodiments.

FIG. 4 shows a flowchart illustrating the process of operating a charging station for a portable electronic device in accordance with one or more embodiments.

FIG. 5 shows a flowchart illustrating the process of operating a charging station for a portable electronic device in accordance with one or more embodiments.

In the figures, like elements are denoted by like reference numerals.

### DETAILED DESCRIPTION

In the following detailed description, numerous specific details are set forth to provide a through understanding of the disclosed embodiments. However, it will be apparent to those skilled in the art that the disclosed embodiments may be practiced without these specific details. In other instances, well-known features have not been described in detail to avoid unnecessarily complicating the description.

Methods, structures, apparatuses, modules, and/or other components described herein may be enabled and operated using hardware circuitry, including but not limited to transistors, logic gates, and/or electrical circuits such as application-specific integrated circuits (ASICs), field-programmable gate arrays (FPGAs), digital signal processors (DSPs), and/or other dedicated or shared processors now known or later developed. Such components may also be provided using firmware, software, and/or a combination of hardware, firmware, and/or software.

The operations, methods, and processes disclosed herein may be embodied as code and/or data, which may be stored on a non-transitory computer-readable storage medium for use by a computer system. The computer-readable storage medium may correspond to volatile memory, non-volatile memory, hard disk drives (HDDs), solid-state drives (SSDs), hybrid disk drives (HDDs), magnetic tape, compact discs (CDs), digital video discs (DVDs), and/or other media capable of storing code and/or data now known or later developed. When the computer system reads and executes the code and/or data stored on the computer-readable storage medium, the computer system performs the methods and processes embodied in the code and/or data.

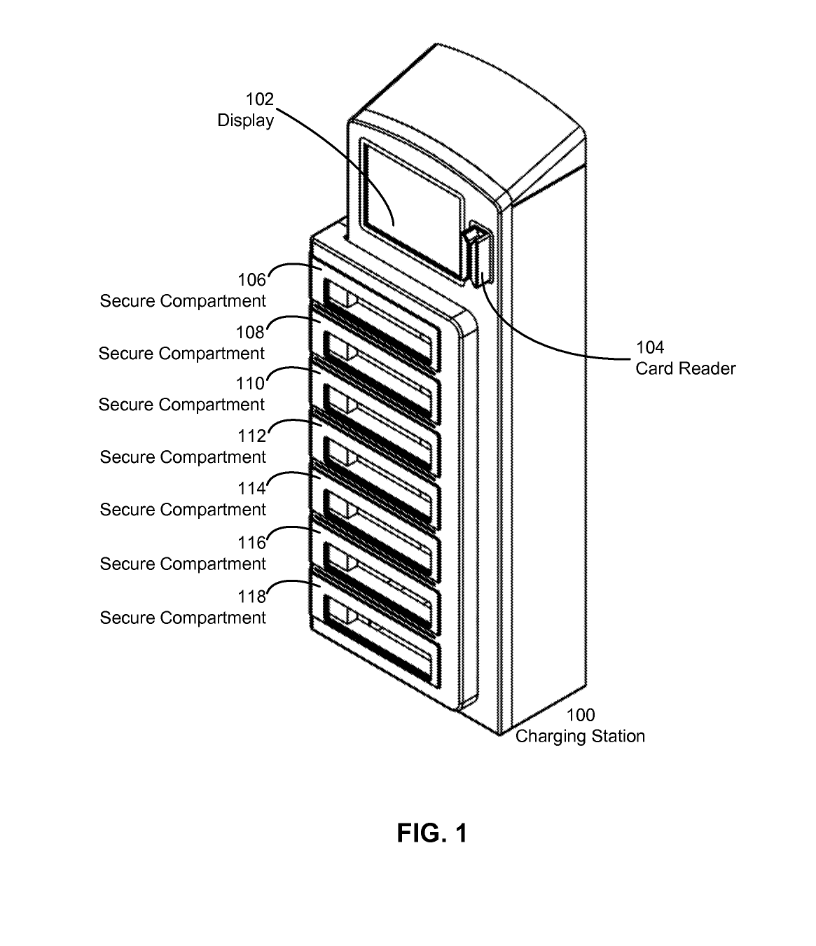

FIG. 1 shows a charging station 100 in accordance with one or more embodiments. Charging station 100 may include a display 102, a card reader 104, and a set of secure compartments 106-118. Charging station 100 may be configured to charge a number of portable electronic devices, such as mobile phones, personal digital assistants (PDAs), tablet computers, portable media players, and/or other battery-powered electronic devices. For example, charging station 100 may be placed in a public location such as an airport, restaurant, bar, and/or gym to allow users at the location to charge their portable electronic devices, even if the users lack access to power outlets and/or chargers that are compatible with the portable electronic devices.

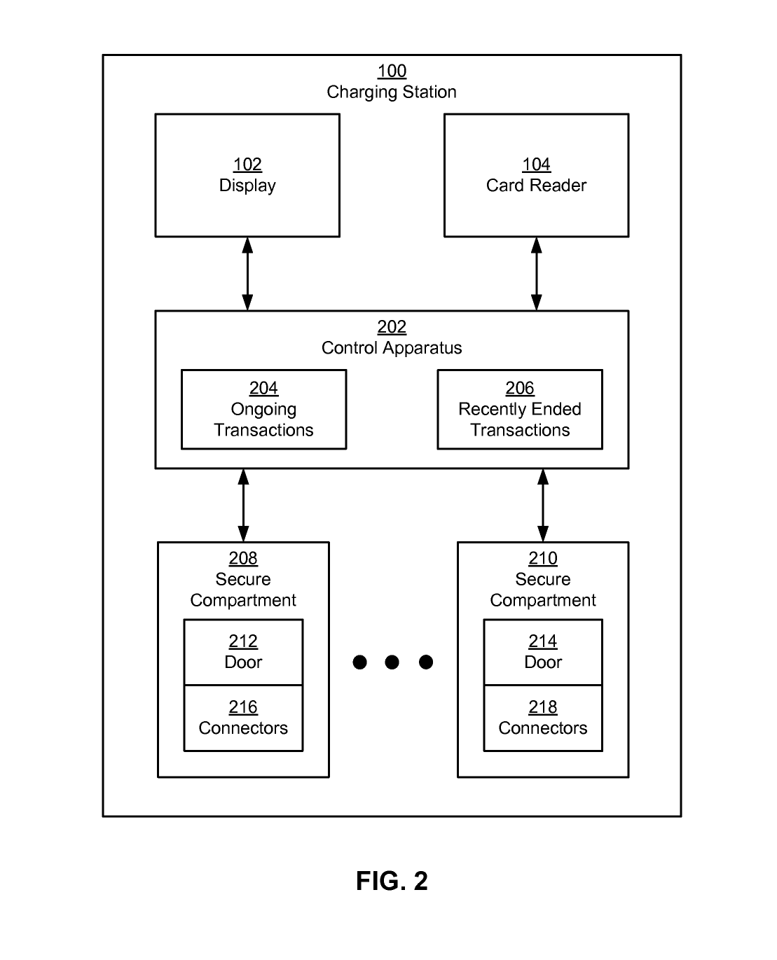

To prevent damage to and/or theft of the portable electronic devices during use of charging station 100, each portable electronic device may be placed in a secure compartment 106-118 (e.g., locker, box, safe, etc.) of charging station 100. A door to the secure compartment may be secured (e.g., locked) to restrict access to the portable electronic device and released (e.g., unlocked or opened) to allow placement of the portable electronic device into the secure compartment and removal of the portable electronic device from the secure compartment. Managing access to portable electronic devices within secure compartments 106-118 is discussed below with respect to FIG. 2.

FIG. 2 shows a schematic of a system in accordance with one or more embodiments. More specifically, FIG. 2 shows a system for operating charging station 100. As shown in FIG. 2, a control apparatus 202 in charging station 100 may interact with a number of users through display 102, card reader 104, and/or other input/output (I/O) devices (not shown) in charging station 100.

Display 102 may correspond to a touchscreen that provides a graphical user interface (GUI) for interacting with charging station 100. During use of charging station 100, a user may provide touch-based input to the touchscreen and obtain instructions, prompts, and/or status information from the user interface shown within the touchscreen. Alternatively, display 102 may correspond to a non-touch-sensitive display that only displays graphical output to the user, and control apparatus 202 may obtain input from the user through card reader 104, a keypad, keyboard, set of buttons, and/or other input devices in charging station 100.

Card reader 104 may correspond to a magnetic-stripe reader that obtains payment information, such as credit card and/or debit card information, from the user. The payment information may then be used to charge the user a fixed or variable amount for using charging station 100 to charge the user's portable electronic device. Card reader 104 may also be configured to read a master card associated with administration of charging station 100. For example, an administrator may swipe the master card through card reader 104 to enable an administrative mode that allows the administrator to open doors 212-214 to secure compartments 208-210 in the charging station, change the brightness of display 102, restart charging station 100, and/or perform other tasks related to the management and/or troubleshooting of charging station 100.

During interaction with the user, control apparatus 202 may use card reader 104, display 102, and/or other I/O devices in charging station 100 to obtain input from the user to charging station 100. For example, control apparatus 202 may allow the user to select a secure compartment 208-210 by pressing a button next to the secure compartment and/or entering an identifier (e.g., numeric code) for the secure compartment into display 102 or a keypad. Control apparatus 202 may also obtain an identifier for the user, such as the payment information (e.g., credit or debit card number), a password, a numeric code (e.g., personal identification number (PIN)), personal information (e.g., name, email address, phone number, etc.), and/or biometric data (e.g., fingerprint, handprint, iris scan, etc.).

Control apparatus 202 may then use the input to manage the user's access to one or more secure compartments 208-210. As mentioned above, the user's portable electronic device may be charged within a secure compartment (e.g., secure compartments 208-210) to prevent damage to and/or theft of the portable electronic device.

In one or more embodiments, control apparatus 202 facilitates interaction with the user by allowing the user to provide the same input to initiate a transaction for charging a portable electronic device within a secure compartment, access the portable electronic device while the portable electronic device is charging within the secure compartment, and end the transaction. To enable such streamlined interaction, control apparatus 202 may track the user's input to charging station 100 and monitor the state of secure compartments 208-210 before, during, and after use of charging station 100 by the user, as discussed in further detail below.

To initiate interaction with the user, control apparatus 202 may prompt the user for input through display 102 and/or another output device. For example, control apparatus 202 may request payment information (e.g., credit card number) and/or an identifier (e.g., name, email address, password, numeric code, etc.) for the user through display 102. The user may provide the payment information and/or identifier by swiping a credit and/or debit card through card reader 104. Alternatively, the user may provide the payment information and/or identifier using a virtual keypad on display 102 and/or a physical keypad (not shown) on charging station 100.

Next, control apparatus 202 may process the input based on a list of ongoing transactions 204 and/or a list of recently ended transactions 206 with charging station 100. Ongoing transactions 204 may be associated with portable electronic devices that are currently charging in secure compartments 208-210, while recently ended transactions 206 may be associated with portable electronic devices that were previously charging in secure compartments 208-210 within a pre-specified period (e.g., minutes, hours, days, etc.).

If the input does not match any ongoing transactions 204 and/or recently ended transactions 206, control apparatus 202 may infer that the input relates to a new transaction, select an unused secure compartment 208-210 for use in charging the portable electronic device, and release (e.g., unlock, open, etc.) a door (e.g., doors 212-214) of the secure compartment. On the other hand, control apparatus 202 may allow the user to select an unused secure compartment for use in charging the portable electronic device by opening the door of the secure compartment, pressing a button next to the secure compartment, and/or entering a numeric code for the secure compartment into a virtual or physical keypad. Once the secure compartment is selected, control apparatus 202 may initiate a transaction associated with charging of the portable electronic device within the secure compartment and store information (e.g., payment information, personal information, secure compartment information) related to the transaction in the list of ongoing transactions 204.

After the door to the secure compartment is released, the user may place the portable electronic device into the secure compartment and connect the portable electronic device to a connector (e.g., connectors 216-218) such as a 30-pin connector and/or a micro-USB connector. Alternatively, the user may position the portable electronic device over an inductive charging plate in the secure compartment. The user may then close the door of the secure compartment, and control apparatus 202 may secure (e.g., lock) the door until valid credentials for opening the door are subsequently provided. While the portable electronic device remains in the secure compartment, the connector and/or inductive charging plate may supply power to a battery of the portable electronic device, and the secured door may prevent damage to and/or theft of the portable electronic device once the user leaves the vicinity of charging station 100.

Control apparatus 202 may also include functionality to detect and manage the presence of two or more portable electronic devices in the secure compartment. For example, control apparatus 202 may use the connectors in the secure compartment to detect the coupling and decoupling of a portable electronic device to each of the connectors. Control apparatus 202 may also use the connectors to monitor a total power consumption associated with the secure compartment and/or a change in power consumption in the secure compartment. The monitored coupling, decoupling, and/or power consumption may then be processed to determine the number of portable electronic devices present in the secure compartment.

If more than one portable electronic device is detected in the secure compartment, control apparatus 202 may process the transaction based on the detected presence of multiple portable electronic devices within the secure compartment. For example, if two portable electronic devices are detected in the secure compartment, control apparatus 202 may cease to supply power to one of the portable electronic devices, increase the fee associated with the transaction, and/or prompt the user to remove one of the portable electronic devices from the secure compartment. Consequently, control apparatus 202 may prevent the user from obtaining an unauthorized “free charge” by ensuring that power delivered to each portable electronic device in the secure compartment is associated with a fee to the user.

The user may subsequently access and/or retrieve the portable electronic device from the secure compartment by providing the same input (e.g., payment information, identifier, etc.) used to initiate the transaction to control apparatus 202. For example, the user may provide a credit card number, email address, phone number, and/or other unique identifier using display 102, card reader 104, and/or another I/O device on charging station 100. If the input matches an ongoing transaction from the list of ongoing transactions 204, control apparatus 202 may obtain a record of the ongoing transaction from the list of ongoing transactions 204, identify the secure compartment using the record, and release the door of the secure compartment.

After the user has access to the portable electronic device within the secure compartment, the user may remove the portable electronic device from the secure compartment or leave the portable electronic device in the secure compartment. For example, the user may remove the portable electronic device if the user is finished with using charging station 100 to charge the portable electronic device. Conversely, the user may access the portable electronic device to perform a task (e.g., check status, send a text message, etc.) and subsequently leave the portable electronic device charging in the secure compartment after the task is complete.

After the user shuts the door, control apparatus 202 may manage the ongoing transaction based on the state of the secure compartment. First, control apparatus 202 may use the connectors, a sensor, a camera, and/or another mechanism in the secure compartment to detect the presence or absence of the portable electronic device in the secure compartment.

If control apparatus 202 detects that the portable electronic device is absent from the secure compartment after the user closes the door, control apparatus 202 may infer that the user has finished using charging station 100 to charge the portable electronic device, and in turn, secure the door and end the ongoing transaction. Control apparatus 202 may also transfer information associated with the transaction from the list of ongoing transactions 204 to a list of recently ended transactions 206. Control apparatus 202 may then keep the information in the list of recently ended transactions 206 for a pre-specified period (e.g., a number of minutes, one hour, one day, one week, etc.).

If control apparatus 202 detects that the portable electronic device is in the secure compartment after the user closes the door, control apparatus 202 may infer that the user wishes to continue charging the portable electronic device. Control apparatus 202 may then secure the door and continue to supply power to the portable electronic device without requiring additional input from the user.

In other words, control apparatus 202 may utilize both the user's actions and the state of the secure compartment to infer the user's intent regarding the use of charging station 100. Such inference of user intent may allow control apparatus 202 to minimize unnecessary interaction with the user, thus improving the user's experience with using charging station 100.

Alternatively, control apparatus 202 may confirm the user's desire to continue charging the portable electronic device after the door is closed by querying the user for approval to continue charging the portable electronic device. For example, control apparatus 202 may provide, within display 102, an option to continue charging the portable electronic device and an option to discontinue charging the portable electronic device. The option to continue charging the portable electronic device may also be associated with an added fee to the user (e.g., to prevent the user from charging a different portable electronic device within the secure compartment for free). If the user selects the option to continue charging the portable electronic device, control apparatus 202 may secure the door and continue to supply power to the portable electronic device. If the user selects the option to discontinue charging the portable electronic device and/or does not select either option within a pre-specified period, control apparatus 202 may release the first door, prompt the user to remove the portable electronic device from the secure compartment, and/or end the transaction.

Those skilled in the art will appreciate that the simplified and/or streamlined interaction between the user and control apparatus 202 may potentially cause problems with the use of charging station 100. For example, the user may accidentally leave the portable electronic device inside the secure compartment without plugging in the portable electronic device and subsequently close the door of the secure compartment. Because control apparatus 202 cannot detect the presence of the portable electronic device in the secure compartment (e.g., through the connectors of the secure compartment), control apparatus 202 may assume that the user has removed the portable electronic device from the secure compartment and end the transaction. As a result, the portable electronic device may remain undetected in the secure compartment, and the user may be unable to retrieve the portable electronic device from the secure compartment.

To mitigate such problems, control apparatus 202 may compare input from the user with the list of recently ended transactions 206. If the input matches a recently ended transaction from the list of recently ended transactions 206, control apparatus 202 may identify the secure compartment associated with the recently ended transaction (e.g., using a record of the recently ended transaction). Control apparatus 202 may then release a door of the secure compartment if the secure compartment is not associated with an ongoing transaction (e.g., from ongoing transactions 204). Once the door is released, the user may access the inside of the secure compartment and fix the problem, either by retrieving the portable electronic device or by plugging the portable electronic device into charging station 100 and resuming the transaction associated with charging of the portable electronic device.

Consequently, the system of FIG. 2 may provide a secure and easy-to-use charging station 100 for portable electronic devices. In particular, the charging of portable electronic devices within secure compartments 208-210 may prevent the portable electronic devices from being stolen, lost, and/or damaged during use of charging station 100. In addition, control apparatus 202 may facilitate interaction with users by maintaining records of ongoing transactions 204 and recently ended transactions 206 and tracking the state of secure compartments 208-210 using doors 212-214 and/or connectors 216-218 of secure compartments 208-210. For example, control apparatus 202 may use the transaction records and/or states of secure compartments 208-210 to select unused secure compartments for use with new transactions, release doors to the secure compartments based on input to charging station 100, and/or enable access to charging portable electronic devices within the secure compartments. Control apparatus 200 may also use the transaction records and/or states of secure compartments 208-210 to automatically end the transactions after the portable electronic devices are removed from the secure compartments and/or enable the retrieval of portable electronic devices that are locked inside the secure compartments but not detected by charging station 100.

Those skilled in the art will appreciate that the system of FIG. 2 may be implemented in a variety of ways. First, control apparatus 202 may be provided by a combination of components, including an embedded controller, microprocessor, field-programmable gate array (FPGA), application-specific integrated circuit (ASIC), and/or one or more software components. In addition, charging station 100 may facilitate interaction with different users by providing a variety of I/O devices, such as microphones, speakers, keyboards, biometric scanners, and/or buttons, in lieu of and/or in addition to display 102 and/or card reader 104. Finally, control apparatus 202 may manage interaction with the users by selectively querying the users for approval and/or confirmation of various actions instead of automatically performing the actions based on the inferred intent of the users. For example, control apparatus 202 may obtain user confirmation before initiating a transaction, releasing a door to a secure compartment containing a charging portable electronic device, continuing to charge the portable electronic device after the door is subsequently closed, charging added fees to an ongoing transaction, and/or ending an ongoing transaction.

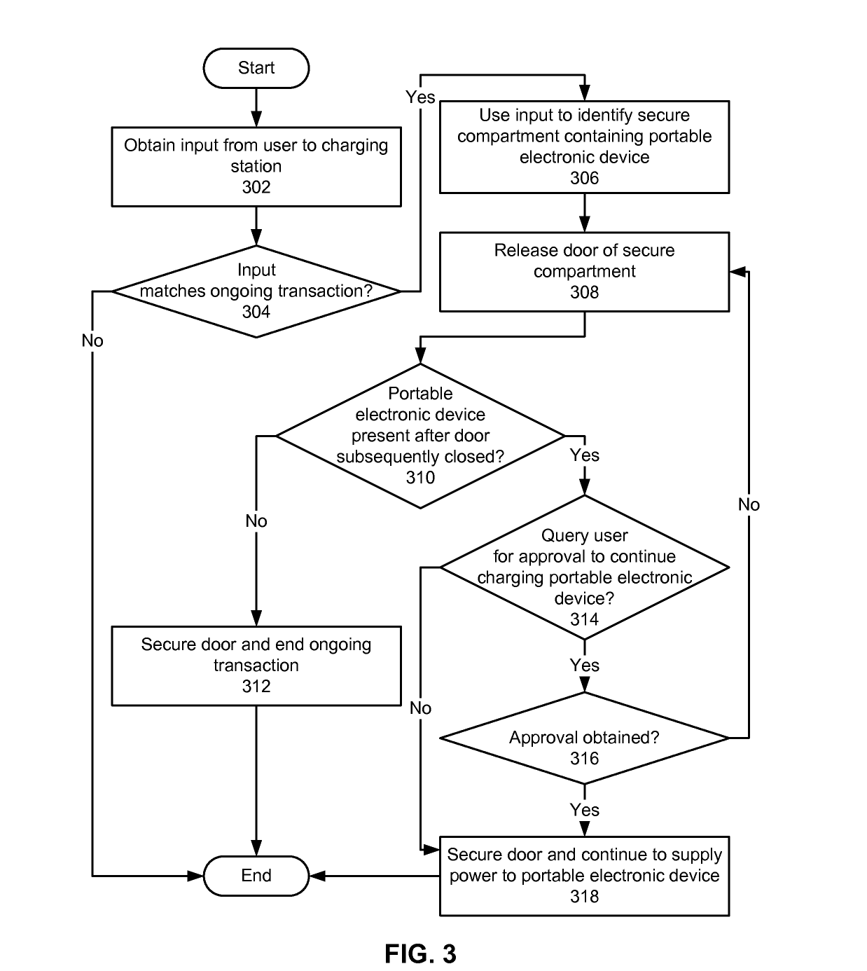

FIG. 3 shows a flowchart illustrating the process of operating a charging station for a portable electronic device in accordance with one or more embodiments. In one or more embodiments, one or more of the steps may be omitted, repeated, and/or performed in a different order. Accordingly, the specific arrangement of steps shown in FIG. 3 should not be construed as limiting the scope of the embodiments.

First, input from a user to the charging station is obtained (operation 302). The input may correspond to a selection of a secure compartment of the charging station and/or an identifier for the user. For example, the user may select a secure compartment for use in charging the portable electronic device by pressing a button and/or entering a numeric code for the secure compartment into a physical or virtual keypad. Alternatively, the selection of the secure compartment may be performed by the charging station. Regardless of how the secure compartment is selected, the user may also provide a password, a numeric code (e.g., PIN), personal information (e.g., name, email address, phone number, etc.), payment information (e.g., credit card number, debit card number, etc.), biometric data, and/or another identifier for the user to the charging station.

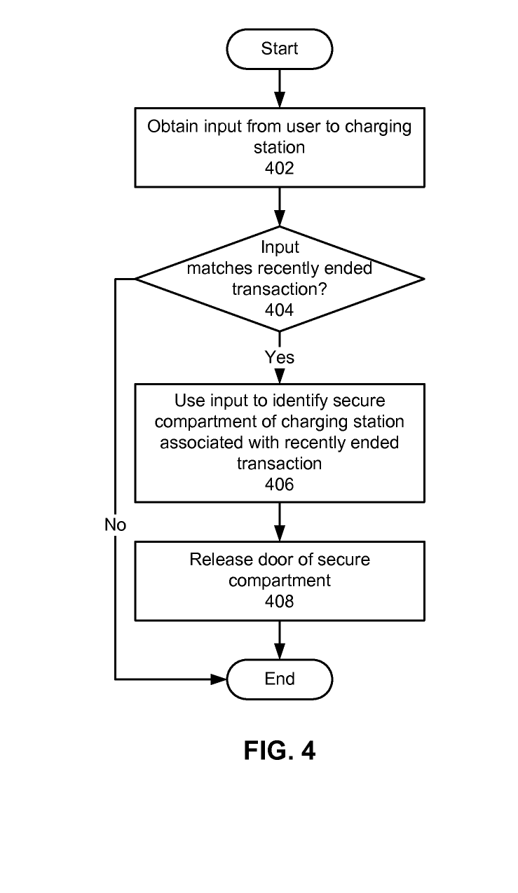

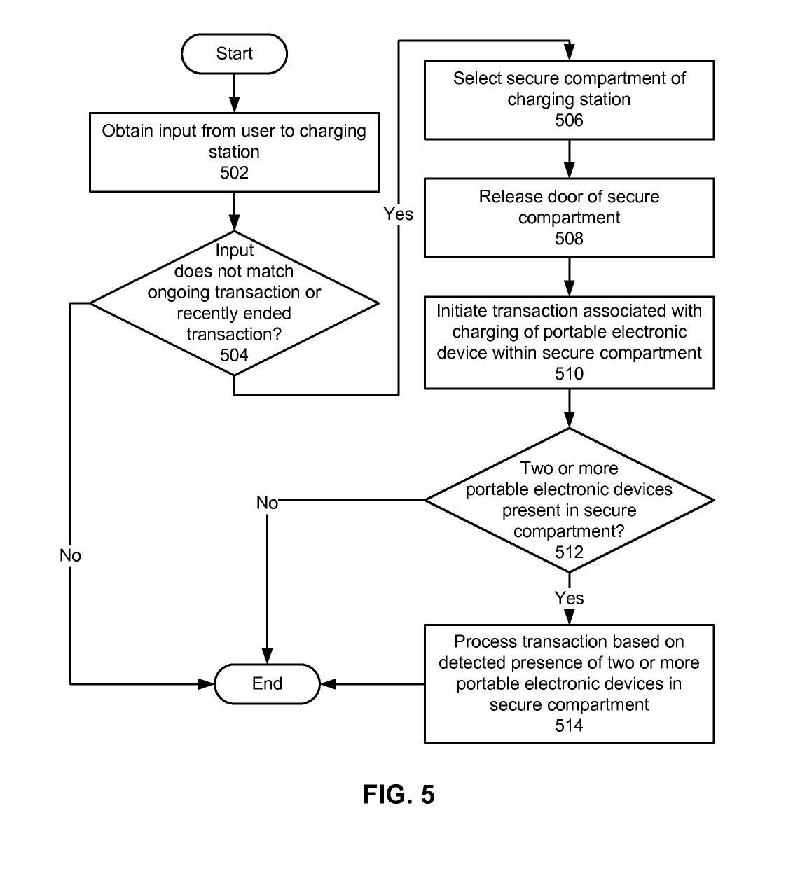

The input (e.g., selection of secure compartment and/or identifier) may be matched to an ongoing transaction (operation 304) associated with charging of the portable electronic device by the charging station. For example, a credit card number provided by the user may be compared to credit card numbers for a list of ongoing transactions to determine if the credit card number matches one of the ongoing transactions. If the input does not match an ongoing transaction, the input may be matched to a recently ended transaction and/or used to initiate a transaction, as discussed in further detail below with respect to FIGS. 4-5.

If the input matches an ongoing transaction, the input is used to identify a secure compartment containing the portable electronic device (operation 306). For example, an identifier for the secure compartment may be obtained from a record of the ongoing transaction. The door of the secure compartment is also released (operation 308). For example, the door may be unlocked and/or opened to allow the user to access the portable electronic device within the secure compartment.

The portable electronic device may or may not be detected as present in the secure compartment after the door is subsequently closed (operation 310) by the user. For example, the portable electronic device may be detected as present if the portable electronic device is connected to a connector within the secure compartment and as absent if the portable electronic device is not connected to the connector. If an absence of the portable electronic device from the secure compartment is detected after the door is subsequently closed, the door is secured (e.g., locked) and the ongoing transaction is ended (operation 312). Moreover, if the portable electronic device is detected as absent but the portable electronic device is still present in the secure compartment, the user may provide the same input to retrieve the portable electronic device, as discussed below with respect to FIG. 4.

If a presence of the portable electronic device in the secure compartment is detected after the door is subsequently closed, the portable electronic device may continue to be charged, with or without querying the user for approval to continue charging the portable electronic device (operation 314). If the user is not queried for approval to continue charging the portable electronic device, the door is secured, and power continues to be supplied to the portable electronic device (operation 318) without requiring additional input from the user. The user may also be charged an added fee for accessing the portable electronic device while the portable electronic device is charging within the secure compartment.

If the user is queried for approval to continue charging the portable electronic device, the approval may or may not be obtained from the user (operation 316). For example, the user may be queried for approval by providing an option to continue charging the portable electronic device and providing an option to discontinue charging the portable electronic device. The approval may be obtained if the user selects the option to continue charging the portable electronic device. On the other hand, the approval may not be obtained if the user selects the option to discontinue charging the portable electronic device and/or fails to respond within a pre-specified period (e.g., a number of seconds).

If the user's approval is obtained, the door is secured, and power continues to be supplied to the portable electronic device (operation 318). As mentioned above, the continued charging the portable electronic device may also be associated with an added fee to the user. If the user's approval is not obtained, the door of the secure compartment is released again (operation 308) to allow the user to retrieve the portable electronic device and end the ongoing transaction (operation 312) and/or approve the continued charging of the portable electronic device using the ongoing transaction (operations 314-318). Subsequent input from the user may continue to be processed using the flowchart of FIG. 3 and/or using the flowcharts of FIGS. 4 and/or 5.

FIG. 4 shows a flowchart illustrating the process of operating a charging station for a portable electronic device in accordance with one or more embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, input from the user to the charging station is obtained (operation 402). The input may match a recently ended transaction (operation 404) associated with charging of the portable electronic device by the charging station. For example, records of recently ended transactions may be kept for a pre-specified period (e.g., five minutes, one hour, one day) after the end of each transaction, and the input may be compared with the records to determine if the input matches one of the recently ended transactions. If the input does not match a recently ended transaction, the input may be used to initiate a transaction, as described in further detail below with respect to FIG. 5, or the input may be used to process an ongoing transaction, as described above with respect to FIG. 3.

If the input matches a recently ended transaction, the input is used to identify a secure compartment of the charging station associated with the recently ended transaction (operation 406), and the door of the secure compartment is released (operation 408) if the secure compartment is not currently used by an ongoing transaction.

The opening of the door to a previously (e.g., recently) used secure compartment instead of a random compartment may facilitate the retrieval of a portable electronic device that has accidentally been locked in the secure compartment. For example, an ongoing transaction associated with charging the portable electronic device in the secure compartment may be ended if the secure compartment's door is closed with the portable electronic device still in the secure compartment but detected as absent in the secure compartment (e.g., if the portable electronic device is disconnected from a connector in the secure compartment). Because the door may be locked after the transaction is complete, the user may not be able retrieve the portable electronic device from the secure compartment without assistance from an administrator. On the other hand, the flowchart of FIG. 4 may allow the user to open the door of the secure compartment and access the portable electronic device by providing the same input associated with the recently ended transaction to the charging station.

FIG. 5 shows a flowchart illustrating the process of operating a charging station for a portable electronic device in accordance with one or more embodiments. In one or more embodiments, one or more of the steps may be omitted, repeated, and/or performed in a different order. Accordingly, the specific arrangement of steps shown in FIG. 5 should not be construed as limiting the scope of the embodiments.

As with the flowcharts of FIGS. 3 and 4, the flowchart of FIG. 5 may begin with obtaining input from a user to the charging station (operation 502). The input may then be processed using the remaining steps of the flowchart of FIG. 5 if the input does not match an ongoing transaction or a recently ended transaction (operation 504). On the other hand, if the input matches an ongoing transaction and/or a recently ended transaction, the input may be processed using the flowcharts of FIGS. 3 and/or 4.

If the input does not match an ongoing transaction or a recently ended transaction, a secure compartment of the charging station is selected (operation 506), and a door of the secure compartment is released (operation 508). A transaction associated with charging of the portable electronic device within the secure compartment is also initiated (operation 510). For example, a record of the transaction containing the input from the user and/or an identifier for the secure compartment may be created and stored in a list of ongoing transactions.

Two or more portable electronic devices may also be detected in the secure compartment (operation 512). The presence of multiple portable electronic devices may be detected using a set of connectors in the secure compartment, a total power consumption associated with the secure compartment, and/or a change in power consumption in the secure compartment. For example, two or more portable electronic devices may be detected if power is being drawn from more than one connector in the secure compartment, the total power consumption in the secure compartment is higher than normal, and/or the power consumption in the secure compartment spikes (e.g., after a second portable electronic device is plugged into a connector). If only one portable electronic device is detected in the secure compartment, charging of the portable electronic device may continue, and subsequent input from the user may be processed using the flowchart of FIG. 3.

If two or more portable electronic devices are detected in the secure compartment, the transaction is processed based on the detected presence of the two or more portable electronic devices in the secure compartment (operation 514). For example, multiple electronic devices in the secure compartment may be managed by ceasing to supply power to at least one of the portable electronic devices, increasing a fee associated with the transaction, and/or prompting the user to remove at least one of the portable electronic devices from the secure compartment.

The detection and management of portable electronic devices in secure compartments described in FIGS. 3-5 may thus ensure that a fee is received for each portable electronic device receiving power from the charging station. For example, the operations of FIGS. 3-5 may prevent “free charges” associated with the concurrent connection of multiple portable electronic devices to connectors within the same secure compartment and/or the serial charging of multiple portable electronic devices using the same secure compartment and/or transaction.

Although the disclosed embodiments have been described with respect to a limited number of embodiments, those skilled in the art, having benefit of this disclosure, will appreciate that many modifications and changes may be made without departing from the spirit and scope of the disclosed embodiments. Accordingly, the above disclosure is to be regarded in an illustrative rather than a restrictive sense. The scope of the embodiments is defined by the appended claims.

What is claimed is:

1. A method for operating a charging station for a portable electronic device, comprising:
obtaining input from a user to the charging station; and
if the input matches an ongoing transaction associated with charging of the portable electronic device by the charging station:
using the input to identify a first secure compartment of the charging station containing the portable electronic device, wherein power is supplied to the portable electronic device within the first secure compartment;
releasing a first door of the first secure compartment; and
upon detecting a presence of the portable electronic device in the first secure compartment after the first door is subsequently closed, securing the first door and continuing to supply power to the portable electronic device without requiring additional input from the user.

2. The method of claim 1, further comprising:
querying the user for approval to continue charging the portable electronic device after the first door is subsequently closed; and
if the approval is not obtained from the user, releasing the first door.

3. The method of claim 2, wherein querying the user for approval to continue charging the portable electronic device involves:
providing an option to continue charging the portable electronic device; and
providing an option to discontinue charging the portable electronic device.

4. The method of claim 3, wherein the option to continue charging the portable electronic device is associated with an added fee to the user.

5. The method of claim 1, further comprising:
upon detecting an absence of the portable electronic device in the first secure compartment after the first door is subsequently closed, securing the first door and ending the ongoing transaction.

6. The method of claim 1, further comprising:
if the input matches a recently ended transaction associated with charging of the portable electronic device by the charging station:
using the input to identify a second secure compartment of the charging station, wherein the second secure compartment is associated with the recently ended transaction; and
releasing a second door of the second secure compartment.

7. The method of claim 6, further comprising:
if the input does not match the ongoing transaction or the recently ended transaction:
selecting a third secure compartment of the charging station;
releasing a third door of the third secure compartment; and
initiating a transaction associated with charging of the portable electronic device within the third secure compartment.

8. The method of claim 7, further comprising:
upon detecting a presence of two or more portable electronic devices in the third secure compartment, processing the transaction based on the detected presence of the two or more portable electronic devices in the third secure compartment.

9. The method of claim 8, wherein the presence of the two or more portable electronic devices in the third secure compartment is detected using at least one of:
a set of connectors in the third secure compartment;
a total power consumption associated with the third secure compartment; and
a change in power consumption in the third secure compartment.

10. The method of claim 8, wherein processing the transaction based on the detected presence of the two or more portable electronic devices in the third secure compartment involves at least one of:
ceasing to supply power to at least one of the two or more portable electronic devices;
increasing a fee associated with the transaction; and
prompting the user to remove at least one of the two or more portable electronic devices from the third secure compartment.

11. The method of claim 1, wherein the input from the user comprises at least one of:
a selection of the first secure compartment; and
an identifier for the user.

12. The method of claim 11, wherein the identifier for the user is at least one of a password, a numeric code, personal information, payment information, and biometric data.

13. The method of claim 1, wherein releasing the first door of the first secure compartment involves at least one of:
unlocking the first door; and
opening the first door.

14. A charging station, comprising:
a set of secure compartments, wherein each of the secure compartments is configured to supply power to a portable electronic device; and
a control apparatus configured to:
obtain input from a user to the charging station; and
if the input matches an ongoing transaction associated with charging of the portable electronic device by the charging station:
use the input to identify a first secure compartment from the set of secure compartments containing the portable electronic device;
release a first door of the first secure compartment; and
upon detecting a presence of the portable electronic device in the first secure compartment after the first door is subsequently closed, secure the first door and continue to supply power to the portable electronic device without requiring additional input from the user.

15. The charging station of claim 14, wherein the control apparatus is further configured to:
upon detecting an absence of the portable electronic device in the first secure compartment after the first door is subsequently closed, secure the first door and ending the ongoing transaction.

16. The charging station of claim 14, wherein if the input matches a recently ended transaction associated with charging of the portable electronic device by the charging station, the control apparatus is further configured to:
use the input to identify a second secure compartment from the set of secure compartments, wherein the second secure compartment is associated with the recently ended transaction; and
release a second door of the second secure compartment.

17. The charging station of claim 17, wherein if the input does not match the ongoing transaction or the recently ended transaction, the control apparatus is further configured to:
select a third secure compartment from the set of secure compartments;
release a third door of the third secure compartment; and
initiate a transaction associated with charging of the portable electronic device within the third secure compartment.

18. The charging station of claim 17, wherein the control apparatus is further configured to:
upon detecting a presence of two or more portable electronic devices in the third secure compartment, process the transaction based on the detected presence of the two or more portable electronic devices in the third secure compartment.

19. The charging station of claim 18, wherein processing the transaction based on the detected presence of the two or more portable electronic devices in the third secure compartment involves at least one of:
ceasing to supply power to at least one of the two or more portable electronic devices;
increasing a fee associated with the transaction; and
prompting the user to remove at least one of the two or more portable electronic devices from the third secure compartment.

20. The charging station of claim 14, wherein the input from the user comprises at least one of:
a selection of the first secure compartment; and
an identifier for the user.
